(19) United States
(12) Patent Application Publication
(10) Pub. No.: US 2005/0247904 A1
(43) Pub. Date: Nov. 10, 2005

(54) Nanocomposite ceramics of oxide and no-oxide phases and methods for producing same

(75) Inventors: Rishi Raj, Boulder, CO (US); Atanu Saha, Boulder, CO (US); Sandeep Shah, Golden, CO (US)

Correspondence Address: PATTON BOGGS, 1660 LINCOLN ST, SUITE 2050, DENVER, CO, 80264, US

(73) Assignee: The Regents Of The University Of Colorado, Boulder, CO (US)

(21) Appl. No.: 10/511,464

(22) PCT Filed: Apr. 28, 2003
(86) PCT No.: PCT/US03/13125

§ 371 Date: Oct. 14, 2004

Related U.S. Application Data
(60) Provisional application No. 60/376,123, filed on Apr. 27, 2002.

(51) Int. Cl. C04B 35/569; C04B 35/571

(52) U.S. Cl. 252/62.9 R; 252/62.9 PZ; 501/88; 501/95.1; 264/640

(57) ABSTRACT

A composite of nanoscale oxide ceramic phases is dispersed in a non-oxide ceramic matrix material. The non-oxide ceramic phase may be silicon-carbon-nitrogen-based, and imparts resistance to mechanical degradation, resistance to chemical degradation, and resistance to oxidation at temperatures up to 1800° C. The nanodispersed oxide phase is selected according to desired functional properties, including coefficient of thermal expansion, rheology, ferromagnetic and superparamagnetic properties, superdielectric properties, and superpiezolectric and electrostrictive properties. A method is provided for making a nanocomposite ceramic fiber having a nanodispersion of zirconia in a silicon-carbon-nitrogen ceramic phase. A method is provided for making a soft ferromagnetic ceramic having a nanodispersion of ferrite in a zirconia in a silicon-carbon-nitrogen ceramic phase.

This invention was made with Government support. The Government has certain rights in this invention.

### BACKGROUND OF THE INVENTION

1. Field of the Invention

The present invention involves methods and materials for ceramics and, more particularly, methods and materials for amorphous nanocomposite ceramics and devices utilizing the same.

2. Statement of the Problem

Formation of ceramics from polymer precursors has received widespread attention recently, mainly because the processing is done at lower temperatures and with simpler procedures than conventional processes of sintering ceramic powders.

The formation of ceramics from polymer precursors is typically performed by first thermosetting the polymer precursor to a solid material, and then pyrolyzing the solid material to form the ceramic.

One of the most interesting groups of such ceramic materials includes amorphous compounds of silicon, carbon, and nitrogen. Amorphous silicon carbonitride (SiCN) is a relatively new material with potential for a wide range of applications requiring materials with multifunctional properties. This potential is due to SiCN being chemically stable at temperatures up to 1500° C., and having excellent resistance to creep, oxidation, and thermal shock. Bulk form SiCN has been fabricated from commercially available polymeric precursors. There are significant shortcomings, however, with present SiCN fabrication methods that have limited its use and prevented many products from being commercially successful. One major reason for this lack of success lies in the nature of the current process used to make polymer-based SiCN materials.

The current process for making polymer-based SiCN materials consists of two steps: thermosetting, which is typically polymerization of a liquid form of the precursor into a rigid plastic body, known as the “green body”, followed by pyrolyzing the rigid plastic into a monolithic SiCN ceramic. These SiCN ceramics are a non-oxide ceramic, as oxygen has been considered generally to be detrimental to the material.

There are shortcomings with the monolithic SiCN ceramics of the prior art. One is that, being non-oxide, they lack functional properties of existing oxide ceramic monolithic components such as magnets, capacitors, ferroelectric actuators, and others. For this reason, the existing SiCN monolithic ceramics, although having superior mechanical and thermo-mechanical properties over oxide monolithic ceramics, are frequently not suitable replacements.

Another problem with the present process for making polymer-based SiCN materials is the respective temperatures at which thermosetting begins and pyrolysis begins, coupled with the rheology of the known precursors. This substantially limits the scope of shapes, forms, and applications of the SiCN products.

One example of this limitation is apparent from the ongoing quest for SiCN fiber. The search for SiCN fiber is not new, as it has been known, in theory anyway, that such fiber could replace graphite fiber for many applications with increased scope of use and improvement in performance. The reason is that graphite exhibits oxidation, devitrification, and degradation above about 800° C. in air. SiCN is stable at considerably higher temperatures. The difficulty, though, is that acceptable quality fibers of SiCN ceramic are difficult to economically produce using the current methods. The fabrication is difficult because, ideally, the precursor would have a rheology suitable for fiber drawing at a temperature just below the thermosetting temperature, and that it have an onset of pyrolysis at a temperature just above the thermosetting temperature. This would allow the fiber to be drawn and immediately thereafter thermoset into a rigid form, which could then be pyrolyzed without losing its shape. Known precursors of SiCN, however, do not have these qualities.

Others have attempted SiCN-type fibers, or alternates, as part of this quest to replace graphite. In the mid-1990s, the Bayer company in Germany announced it had a process for drawing fibers from silicon boron carbonitride (SiBCN); however, this process is known in the art to be too expensive and has not evolved into a successful commercial venture. Nicalon has been used, but Nicalon fibers devitrify at about 1100° C. to 1300° C.

### SOLUTION

The present invention advances the art and overcomes the aforementioned problems by a composite of nanoscale oxide ceramic phases dispersed in a non-oxide ceramic matrix material. The composite achieves new synergies in the properties of the composite, not only combining the properties of the oxide and non-oxide materials into one composite material, but also providing a new genre of materials where the nanoscale dispersion of the oxide phase leads to novel properties that cannot be obtained in the coarser microstructure of the monolithic oxide materials. In a preferred embodiment, the non-oxide ceramic is silicon-carbon-nitrogen-based and the matrix of this phase imparts resistance to mechanical degradation, resistance to chemical degradation, and resistance to oxidation at temperatures up to 1800° C. The nanodispersed oxide phase imparts other “functional” properties, in addition to the high temperature properties of the matrix, to the composite, including: (a) tailored coefficient of thermal expansion; (b) superparamagnetic properties up to very high temperatures; (c) super ferromagnetic properties; (d) superdielectric properties; and (e) superpiezolectric and electrostrictive properties, etc. The term “super” is applied to these composites for two reasons: (i) because the composites have mechanical and chemical durability at high temperatures, which cannot be sustained in the monolithic oxide materials; and (ii) because the nanoscale dispersion of the oxide phase often leads to novel functional behavior that is not obtained in microscale, monolithic, polycrystalline oxide materials.

The dispersion of the functional oxide ceramics in an amorphous non-oxide matrix of silicon carbon and nitrogen is readily obtained via the methods of this invention, and provides functional as well as mechanical properties superior to, and additional to, those found in their monolithic counterparts. These nanocomposites can replace functional oxide ceramic monolithic components such as magnets, capacitors, ferroelectric actuators, and others. Industries including mechanical, electrical, electronic, telecommunication, aerospace, and others will find wide applicability of this invention. This invention is, therefore, a paradigm shift for the functional ceramic monoliths.

One embodiment of the invention includes a nanoscale dispersion of predominantly crystalline oxide phases in a predominantly amorphous matrix of a non-oxide ceramic phase. In the preferred embodiment, the non-oxide ceramic phase is composed primarily of the elements silicon, carbon, and nitrogen, but may contain other dopants, such as boron, in order to control the properties of the matrix phase. The phrase “silicon-carbon-nitrogen based material” is defined herein as a predominantly amorphous matrix of a non-oxide ceramic phase, composed primarily of the elements silicon, carbon, and nitrogen, but which may contain other dopants.

The dispersed oxide phase includes, but is not limited to, zirconia, alumina, spinels (e.g., nickel iron oxides), oxides of iron, perovskites (e.g., barium titanate), ceramics with piezoelectric properties (e.g., PZT), dielectric materials (e.g., barium strontium titanate), other perovskites, sometimes referred to as ABO₃-type materials, and any other suitable oxide ceramics.

Another embodiment of the invention includes a material containing a nanodispersion of zirconia in a SiCN matrix. The matrix phase imparts resistance to mechanical deformation, resistance to oxidation, and resistance to chemical degradation at temperatures up to 1800° C.

In the preferred embodiment, the polymeric precursor materials include silanes, silazanes, and polysilazanes which result in SiCN ceramics upon crosslinking and pyrolysis. The composition of the ceramic product can be varied by appropriate selection of the polymeric precursor material and the pyrolysis environment, and to a lesser extent, by appropriate selection of the casting conditions. One suitable polysilazane is Ceraset™, manufactured and distributed by Kion Corporation, Columbus, Ohio. In accordance with the present invention, the crosslinking can be accomplished by any suitable polymerization reaction known in the art that yields the desired crosslinked polymeric structure. Pyrolysis under argon or nitrogen at temperatures typically less than approximately 1400° C. results in SiCₓN_{y}, where x and y can be varied using a mixture of ammonia and argon.

Another embodiment of the invention includes a fiber formed of the nanodispersion of zirconia in a SiCN matrix. The zirconia phase allows drawing fibers from a commercial source of the polymer that is used in the fabrication of SiCN, such as Ceraset™. These fibers have a far superior chemical stability at high temperatures as compared to presently available non-oxide fibers, collectively known as Nicalon fibers.

Still another embodiment of the invention includes a nanodispersion of iron oxide in a SiCN matrix, which exhibits remarkable magnetic properties, and superparamagnetic behavior, normally not seen in monolithic ferromagnetic oxide-based ceramics. One aspect of this embodiment is the polymer-derived SiCN matrix having chemical stability at elevated temperatures and excellent resistance to creep, oxidation, and thermal shock. Ferromagnetic ceramics like Fe₂O₃ and Fe₃O₄ have poor mechanical strength, high coercivity, and high hysterisis loss.

A further aspect of the invention includes a nanocomposite ceramic having a tailored coefficient of thermal expansion. The nanocomposite may be a nanodispersion of zirconia in a SiCN matrix. The coefficient of thermal expansion of SiCN is tailored by the incorporation of 1 weight percent to 99 weight percent zirconium oxide. Yet another aspect of the invention is a sealing material for multilayer fuel cell structures at high temperature, comprising a nanocomposite ceramic having a tailored coefficient of thermal expansion. The nanocomposite may be a nanodispersion of zirconia in a SiCN matrix.

Another aspect of the invention is a nanodispersion of barium-strontium-titanate in a SiCN matrix, which has superdielectric properties as well as superior mechanical structure and thermal stability.

Numerous other features, objects and advantages of the invention will become apparent from the following description when read in conjunction with the accompanying drawings.

### BRIEF DESCRIPTION OF THE DRAWINGS

FIG. 1 is a photomicrograph of a nanocomposite Si—C—N—Zr—O fiber specimen obtained via a method of the present invention;

FIG. 2 is a graph comparing the oxidation resistance of a nanocomposite Si—C—N—Zr—O fiber via a method of the present invention with that of a pure SiCN fiber, each obtained via a method of the present invention;

FIG. 3 is a graph comparing the thermal stability of the Si—C—N—Zr—O fiber prepared via a method of the present invention with that of a commercially available Nicalon fiber (Nicalon NL202);

FIG. 4 is a photomicrograph of a Si—C—N—Zr—O fiber specimen obtained via a method of the present invention; and

FIG. 5 is a graph comparing the hysterisis curve of a prior art ferrite magnetic material with that of an amorphous nanocomposite Si—C—N—Fe—O magnetic material specimen obtained via a method of the present invention.

### DETAILED DESCRIPTION OF THE PREFERRED EMBODIMENT

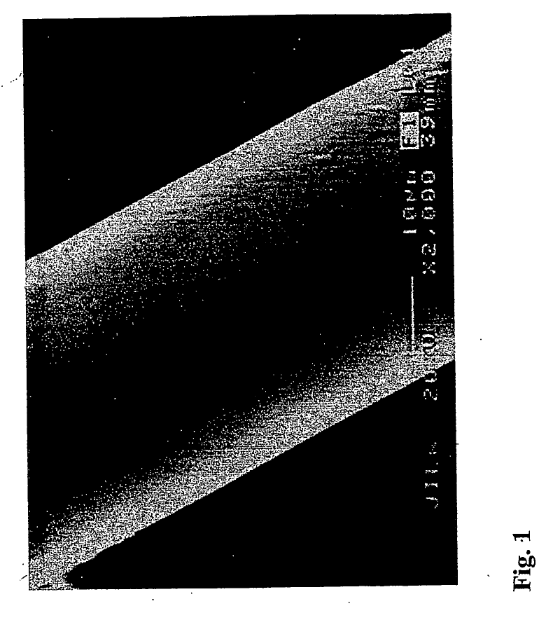

FIG. 1 is a photomicrograph of a nanocomposite Si—C—N—Zr—O fiber specimen, comprising a nanodispersion of zirconia in a SiCN matrix, obtained via the following described method of the present invention. The specimen was produced from commercially available Ceraset™ and zirconium propoxide (Zr-n-p) dissolved in propanol. They are the sources of SiCN and ZrO₂, respectively. The yield of SiCN and ZrO₂ from Ceraset™ and Zr-n-p solution, after pyrolyzing at 1000° C. in N₂, was measured to be 78% and 28% weight percentage respectively. Based on this yield, Ceraset and Zr-n-p solution were taken in appropriate proportion so as to get 10% volume percentage of ZrO₂ in the fiber after pyrolysis at 1000° C. in N₂. First, the Ceraset™ and the Zr-n-p solution were mixed together and heat treated at 160° C. to yield viscous liquid. The fiber was then drawn from this viscous liquid at room temperature. The fiber then was thermosetto a rigid solid above 160° C. and pyrolyzed at 1000° C.

The SiCN matrix phase of the Si—C—N—Zr—O fiber of the invention imparts resistance to mechanical deformation, resistance to oxidation, and resistance to chemical degradation at temperatures up to 1800° C. The invention's addition of the zirconia phase changed the rheology of the SiCN precursor to enable drawing of fibers from Ceraset™ and other commercially available sources of the polymer used in the fabrication of SiCN. Otherwise, the fiber drawing from these commercially available precursors is not possible.

As can be seen from the FIG. 1 photomicrograph, the surface of the specimen Si—C—N—Zr—O fiber is dense and free from defects. X-ray diffraction confirmed both the SiCN and ZrO₂ as being in an amorphous phase. The fracture strength and Young's modulus of Si—C—N—Zr—O fiber were evaluated to be 2.6 GPa and 160 GPa respectively, with a fiber diameter of 11 μm. As a comparison, the highest reported fracture strength of SiCN fiber from laboratory derived precursor is 2.5 GPa, with a fiber processing involving expensive y-ray curing.

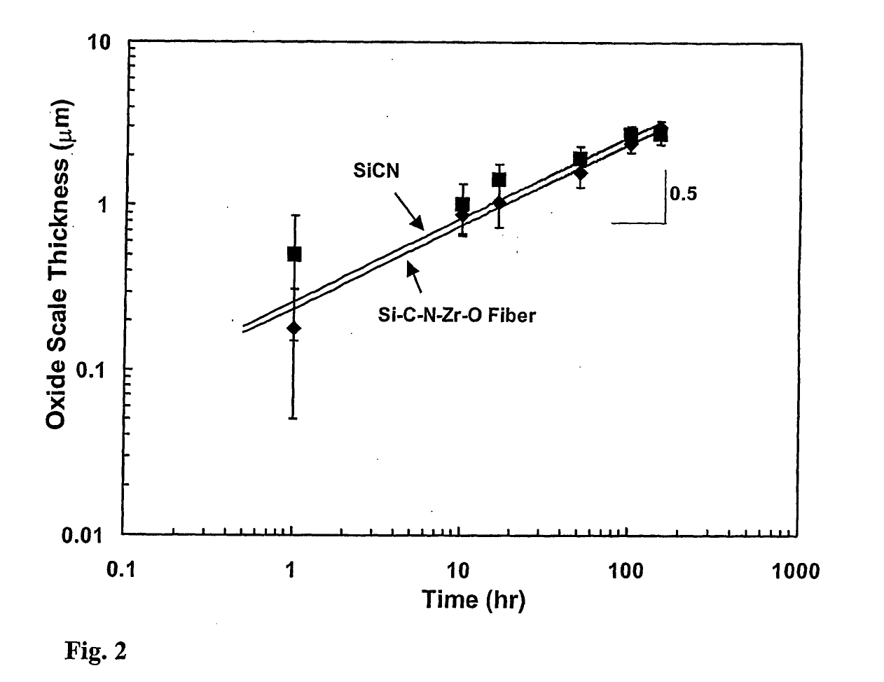

FIG. 2 is a graph comparing the oxidation resistance of pure SiCN with a nanocomposite Si—C—N—Zr—O fiber of the invention, formed of SiCN with a nanodispersion of 10% ZrO₂ by volume. As seen in the FIG. 2 graph, the Si—C—N—Zr—O fiber has significantly better oxidation resistance than SICN alone. Accordingly, the Si—C—N—Zr—O fiber formed by the invention, using the readily prepared modified precursor, possesses both excellent and superior fracture strength and oxidation resistance compared to SiCN fiber.

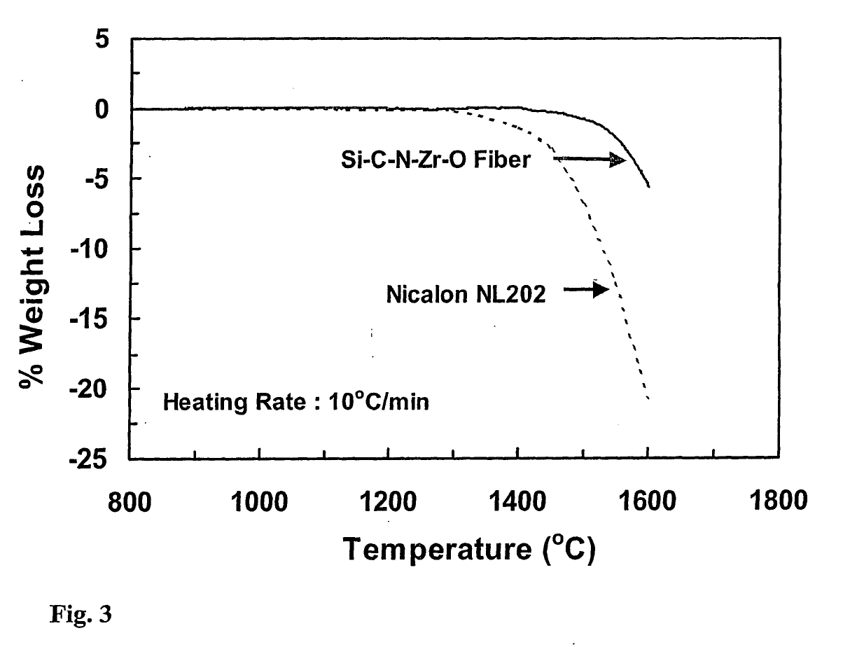

FIG. 3 is a graph comparing the thermal stability of the Si—C—N—Zr—O fiber of the invention with that of a commercially available Nicalon fiber (Nicalon NL202). The experiment was carried out under identical conditions for both cases. Under these identical experimental conditions, initiation of thermal degradation for commercially available Nicalon fiber starts at 1300° C. On the other hand, Si—C—N—Zr—O fiber is stable up to approximately 1500° C. Moreover, the weight loss at 1600° C. is only 5% for S—C—N—Zr—O fiber, while that for Nicalon fiber is observed to be approximately 20%. Thus, the present invention's Si—C—N—Zr—O fibers have a far superior chemical stability at high temperatures as compared to presently available non-oxide fibers such as Nicalon fibers.

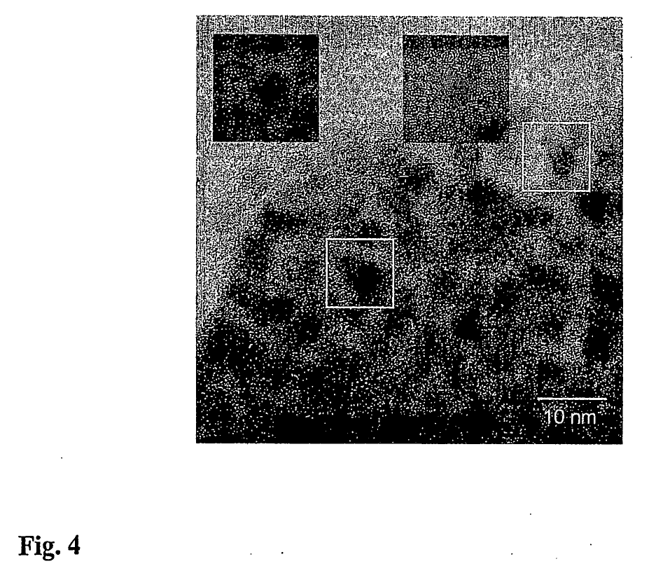

FIG. 4 is a photomicrograph of another SiCN—ZrO₂ fiber specimen obtained via the present invention. The specimen shown in FIG. 4 was pyrolyzed at 1300° C. The surface shows uniform dispersion of nanoparticles of ZrO₂ in a SiCN matrix.

The Si—C—N—Zr—O fiber of the present invention is contemplated to have significantly improved performance and a much wider scope of applications compared to the currently used graphite and/or Nicalon fibers. The contemplated applications include those involving extreme environments of temperature and/or chemical reactants, including those causing oxidation. These are important because graphite and Nicalon typically suffer from oxidation, devitrification and degradation in such environments. Graphite oxidizes (burns) above about 800° C. in air, while Nicalon fibers degrade by devitrification at about 1100° C. to 1300° C. The Si—C—N—Zr—O fibers of the invention are stable at temperatures up to 1500° C. in an air environment.

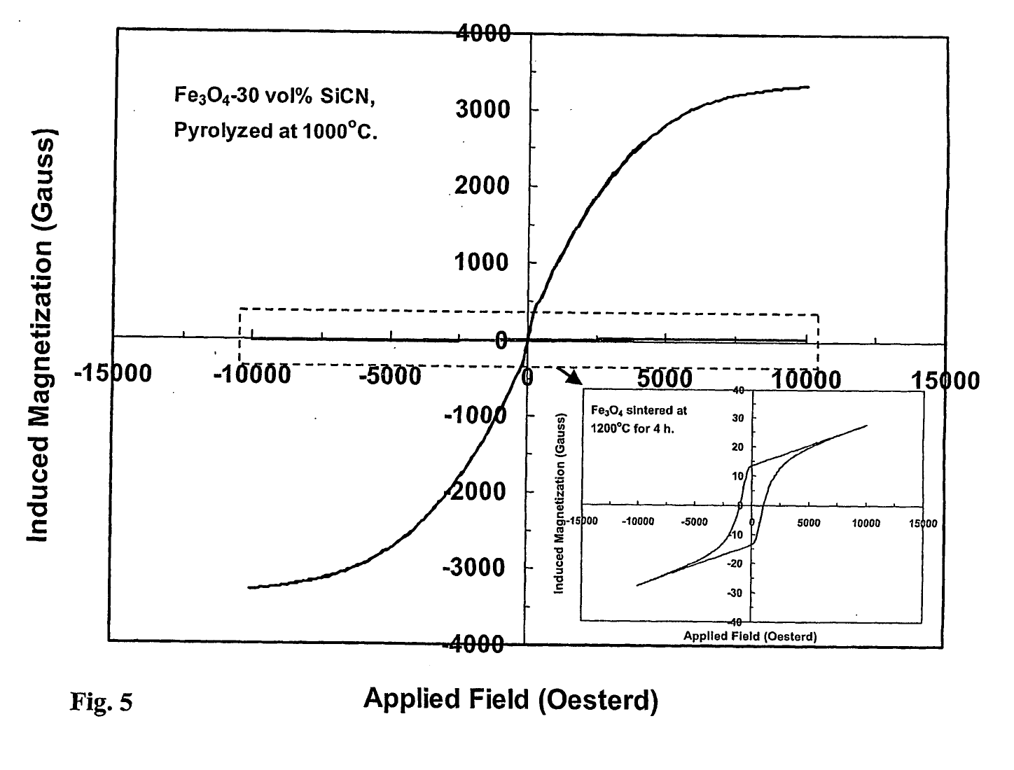

Particular contemplated applications of Si—C—N—Zr—O fibers of the present invention include materials for brakes in aircraft, where the current practice is to use graphite fibers, heat exchangers in energy conversion systems, and applications in space technologies. Another embodiment of the invention is an amorphous nanocomposite Si—C—N—Fe—O soft ferrite magnetic material. FIG. 5 is a graph illustrating one of the benefits of this material. The graph of FIG. 5 plots induced magnetization in Gauss as function of applied field in Oesterds. The inset shows the same graph for a prior art material, Fe₃O₄, and a clearly drastic improvement in a sample's hysterisis loss when compared to a sample of the prior art ferrite magnetic material.

The FIG. 5 sample composite was made by a polymer derived route using powdered Fe₃O₄ obtained from Fisher Scientific, Fair Lawn, N.J., and Ceraset™, obtained from Kion Corporation, Columbus, Ohio. The powdered Fe₃O₄ was dispersed in liquid Ceraset™ using an ultrasonic bath. The dispersion was heat treated at 400° C. in a nitrogen environment to crosslink the precursor mixture. The heat treated composition was ball milled, followed by pelletization by warm pressing at 350° C. and 30 MPa. The pellet was then pyrolyzed under a flowing nitrogen environment at 1000° C., with very slow heating and cooling rates. The mixing ratio of powdered Fe₃O₄ to liquid Ceraset™ was such that the final pyrolyzed ceramic composition was Fe₃O₄-70% and SiCN-30% by volume in final composite.

As seen from the FIG. 5 “Magnetization vs. Applied Field” curve, the amorphous nanocomposite SiCN—Fe₃O₄ of this invention has near zero hysterisis. Further, the FIG. 5 curve for the ferrite shows a coercive force of about 1000 Oesterds, while the nanocomposite exhibits a coercive force of only 10 Oesterds.

The nanocomposite of SiCN and ferrite of this invention has remarkable properties which have never before been seen in monolithic ferrites, including: (a) ten to two hundred times the permeability of monolithic polycrystalline ferrites; and (b) nearly zero coercive field and negligible hysteretic loss.

Further, the SiCN—Fe₃O₄ composite can be fabricated by this invention at low temperatures such as, for example, less than 1000° C. In comparison, monolithic ferrites are prepared by the sintering process at much higher temperatures (1200° C. to 1400° C.). The sintering process often employs sintering aids that can degrade the properties of the material. The polymer derived process of the invention does not involve any sintering aids.

Still further, the polymer-derived SiCN matrix of this embodiment has chemical stability at elevated temperatures and excellent resistance to creep, oxidation, and thermal shock. Ferromagnetic ceramics, like Fe₂O₃ and Fe₃O₄, have poor mechanical strength. The fracture strength of SiCN—Fe₃O₄ nanocomposites was measured to be 175 MPa. This composite does not exhibit any degradation in magnetic properties when in use at a temperature of approximately 500 C in air. Therefore, the SiCN—Fe₃O₄ nanocomposite of this invention has these benefits in addition to its clearly superior coercivity and hysterisis characteristics.

The soft ferrite nanocomposite SiCN and ferrite materials produced by the methods of this invention are contemplated to have extensive applications including, for example, without deflection yokes of cathode ray tubes (CRT), power switch transformers, retro-sweeping transformer for televisions, radio antennae, chokes, rotary transformers of audio visual (AV) machines, ballast of energy saving lights, and transformers.

A further aspect of the invention is attained by using zirconium oxide as the oxide phase of the oxide/non-oxide nanodispersion ceramic of the invention. Zirconium oxide provides selective tailoring of the coefficient of thermal expansion of the SiCN matrix, ranging from 1 weight percent to 99 weight percent zirconium oxide. A contemplated product of zirconium oxide as the oxide phase nanodispersed in the non-oxide SICN is a sealing material for multilayer fuel cell structures, usable at high temperatures.

Another aspect of the invention is a nanodispersion of barium-strontium-titanate in a SiCN matrix, which is predicted by the present inventors as likely having superdielectric properties as well as superior mechanical structure and thermal stability.

Particular contemplated applications of the Si—C—N—Zr—O system also include multilayer coating systems in high temperature components such as blades, combustors, nozzles, and linings in gas turbine engines. The polymer route to processing and the nanoscale microstructure of these coatings can be an advantage in providing thermal and environmental barriers for higher performance in high temperature and aggressive environments.

Each of the above examples shows a different and novel aspect of the composite materials according to the present invention. The scope of this invention, however, is not limited to these examples but extends generally to composites that are constructed from the SiCN-based non-oxide matrix, and the broad range of oxide ceramics described above. The present invention advances the art by dispersing crystalline oxide ceramics at nanometer scale in noncrystalline, non-oxide ceramics to impart various functional properties to the composite. The functional properties exhibited by the composite far exceed those predictable, with any reasonable degree of certainty, by a simple rule of mixtures for composites. These composites, according to the invention, exhibit better mechanical properties than their monolithic counterparts. Further, the invention's methods of dispersing functional oxide ceramics in an amorphous non-oxide matrix are readily carried out.

It should be understood that the particular embodiments shown in the drawings and described within this specification are for purposes of example and should not be construed to limit the invention which will be described in the claims below.

1. a ceramic nanocomposite, comprising:
a substantially amorphous matrix of non-oxide ceramic phase; and
a nanoscale dispersion of crystalline oxide phases in said substantially amorphous matrix.

2. A ceramic nanocomposite according to claim 1 wherein said non-oxide ceramic phase includes a silicon atom, a carbon atom, and a nitrogen atom.

3. A ceramic nanocomposite according to any of claim 1 wherein said crystalline oxide phases include crystalline oxide phases from the group consisting of zirconia, alumina, spinels, and oxides of iron.

4. A ceramic nanocomposite according to any of claim 1 wherein said crystalline oxide phases include a perovskite.

5. A ceramic nanocomposite according to any of claim 1 wherein said crystalline oxide phases include a piezoelectric material.

6. A ceramic nanocomposite according to any of claim 1 wherein said crystalline oxide phases include a dielectric material.

7. A method for producing a nanocomposite ceramic fiber, comprising steps of:
providing a primary precursor, said primary precursor being a precursor of a non-oxide ceramic;
mixing a secondary precursor with said primary precursor to form an intermediate mixture, said secondary precursor being a precursor of an oxide ceramic;
heating said intermediate mixture to a viscous state;
drawing said viscous intermediate mixture into a fiber;
thermosetting said fiber into a rigid state; and
pyrolyzing said fiber to form a nanocomposite fiber comprising a nanophase distribution of said oxide ceramic within said non-oxide ceramic.

8. A method as in claim 7 wherein said thermosetting is performed at a temperature above 160° C.

9. A method for producing a nanocomposite fiber according to claim 7 wherein said oxide ceramic is a metal oxide ceramic and said secondary precursor is an organo-metallic precursor of said metal oxide ceramic.

10. A method for producing a nanocomposite fiber according to claim 7 wherein said non-oxide ceramic contains a silicon atom, a carbon atom, and a nitrogen atom.

11. A method for producing a nanocomposite fiber according to claim 7 wherein said oxide ceramic contains atoms selected from groups III and IV of the periodic system of the elements or transition metals or lanthanoid metals and oxygen.

12. A method for producing a nanocomposite fiber according to claim 7 wherein said oxide ceramic contains a zirconium atom and an oxygen atom.

13. A method for producing a nanocomposite fiber according to claim 7 wherein said primary precursor does not have any temperature to make it viscous for drawing fiber, has a first thermosetting temperature, and has a first pyrolyzing temperature, and wherein said secondary precursor has a first drawing temperature to make it viscous for fiber drawing, has a second thermosetting temperature, and has a second pyrolyzing temperature; wherein a mixture of said primary and secondary precursors has a second drawing temperature to make it viscous for drawing fiber, has a third thermosetting temperature close to said second drawing temperature, and a third pyrolyzing temperature.

14. A nanocomposite ceramic fiber, comprising:
a non-oxide ceramic; and
a nanophase distribution of an oxide ceramic within said non-oxide ceramic.

15. A nanocomposite ceramic fiber according to claim 14 wherein said non-oxide ceramic is amorphous.

16. A nanocomposite ceramic fiber according to claim 14 wherein said oxide ceramic is amorphous.

17. A nanocomposite ceramic fiber according to claim 14 wherein said non-oxide ceramic contains a silicon atom, a carbon atom, and a nitrogen atom.

18. A nanocomposite ceramic fiber according to claim 14 wherein said oxide ceramic contains atoms selected from groups III and IV of the periodic system of the elements or transition metals or lanthanoid metals and oxygen.

19. A nanocomposite ceramic fiber according to claim 14 wherein said oxide ceramic contains a zirconium atom and an oxygen atom.

20. A method for making a ceramic nanocomposite magnet, comprising steps of:
mixing a ferrite powder in a polymeric precursor of silicon carbonitride to obtain a liquid precursor dispersion mixture;
crosslinking said liquid precursor dispersion mixture into an interim solid body;
powdering said interim solid body into an interim powder;
pelletizing said interim powder into an interim pellet; and
pyrolyzing said interim pellet into a nanocomposite of silicon carbonitride and ferrite.

21. A method for making a ceramic nanocomposite magnet according to claim 20 wherein said mixing is carried out with an ultrasonic bath.

22. A method for making a ceramic nanocomposite magnet according to claim 20 wherein said crosslinking step includes heating said liquid precursor dispersion mixture to at least approximately 400° C.

23. A method for making a ceramic nanocomposite magnet according to claim 21 wherein said crosslinking step includes heating said liquid precursor dispersion mixture to at least approximately 400° C.

24. A method for making a ceramic nanocomposite magnet according to claim 20 wherein said pelletizing step includes heating and compressing said interim powder in a pellet-shaped mold mixing.

25. A method for making a ceramic nanocomposite magnet according to claim 20 wherein said mixing step mixes said liquid precursor dispersion mixture to have a nanocomposite composition of approximately 70% ferrite and 30% silicon carbonitride, by volume.

26. A method for making a ceramic nanocomposite magnet according to claim 20 wherein said mixing comprises mixing said liquid precursor dispersion mixture to have a nanocomposite composition of substantially 70% ferrite and 30% silicon carbonitride, by volume.

27. A method for making a ceramic nanocomposite magnet according to claim 20 wherein said mixing step mixes said ferrite powder and polymeric precursor of silicon carbonitride in a ratio such that said nanocomposite of silicon carbonitride and ferrite has a coercivity approximately two orders of magnitude less than a coercivity of a ferrite magnetic material.

28. A method for making a ceramic nanocomposite magnet according to claim 20 wherein said mixing comprises mixing said ferrite powder and polymeric precursor of silicon carbonitride in a ratio such that said nanocomposite of silicon carbonitride and ferrite has a coercivity substantially two orders of magnitude less than a coercivity of a ferrite magnetic material.

29. A method for making a ceramic nanocomposite magnet according to claim 20 wherein said crosslinking step includes heating said liquid precursor dispersion mixture to at least approximately 400° C. in a nitrogen atmosphere.

30. A method for making a ceramic nanocomposite magnet according to claim 20 wherein said crosslinking includes heating said liquid precursor dispersion mixture to at least approximately 400° C. in a nitrogen atmosphere.

31. A method for making a ceramic nanocomposite magnet according to claim 20 wherein said pyrolyzing includes heating said pellet to a temperature of approximately 1000° C.

32. A method for making a ceramic having a predetermined coefficient of thermal expansion, said method comprising:
providing a primary precursor, said primary precursor being a precursor of a non-oxide ceramic having a first coefficient of thermal expansion;
mixing a secondary precursor with said primary precursor to form an intermediate mixture, said secondary precursor being a precursor of an oxide ceramic having a second coefficient of thermal expansion;
thermosetting intermediate mixture into an intermediate material; and
pyrolyzing said intermediate material to form a nanocomposite ceramic comprising a nanophase distribution of said oxide ceramic within said non-oxide ceramic,
wherein said mixing comprises mixing said secondary precursor and said primary precursor in a ratio such that said nanocomposite ceramic has said predetermined coefficient of thermal expansion.

33. A method for making a ceramic having a predetermined coefficient of thermal expansion according to claim 32 wherein said oxide ceramic includes a zirconium atom.

34. A method as in claim 32 and further including:
providing a substrate;
prior to said step of pyrolyzing, applying said intermediate mixture or said intermediate material to said substrate; and
wherein said mixing comprises mixing said secondary precursor and said primary precursor in a ratio such that said nanocomposite ceramic has a coefficient of thermal expansion matched to said substrate.

35. A method as in claim 34 wherein said coefficient of thermal expansion is matched to said substrate at temperatures of 500° C. or higher.

36. A method as in claim 34 wherein said substrate comprises a metallic or ceramic material.

37. A method as in claim 34 wherein said providing, mixing, applying, thermosetting, and pyrolyzing are repeated to provide a graded nanocomposite ceramic coating.

38. A ceramic coated structure, comprising:
a substrate; and
a ceramic nanocomposite coating comprising a crystalline oxide ceramic in a substantially non-oxide ceramic, said coating having a coefficient of thermal expansion to match said substrate.

39. The structure of claim 38 wherein said substrate is either metallic or ceramic.

40. The structure of claim 38 wherein said coating is a multilayer graded coating in which each layer has a different proportion of said crystalline oxide ceramic to said non-oxide ceramic.

41. The structure of claim 38 wherein said coating imparts resistance to corrosion at high temperatures.

42. A ceramic nanocomposite according to claim 2 wherein said crystalline oxide phases include crystalline oxide phases from the group consisting of zirconia, alumina, spinels, and oxides of iron.

43. A ceramic nanocomposite according to claim 2 wherein said crystalline oxide phases include a perovskite.

44. A ceramic nanocomposite according to claim 2 wherein said crystalline oxide phases include a piezoelectric material.

45. A ceramic nanocomposite according to claim 2 wherein said crystalline oxide phases include a dielectric material.
